(19) United States
(12) Patent Application Publication
(10) Pub. No.: US 2012/0078810 A1
(43) Pub. Date: Mar. 29, 2012

(54) System and method to analyze current mutual funds and exchange traded funds for individuals and then provide automated potentially suitable trade suggestions by using website-databases cross-referencing and the internet

(76) Inventor: Matthew Joseph McGrath, New York, NY (US)

(21) Appl. No.: 12/889,809

(22) Filed: Sep. 24, 2010

(51) Int. Cl. G06Q 40/00

(52) U.S. Cl. 705/36 R

(57) ABSTRACT

A system and method to analyze current mutual funds and exchange traded funds for individuals and then provide them automated suitable trade suggestions by using website-databases cross-referencing and the internet by recognizing and categorizing their current fund holdings and selecting a better replacement fund available on the current retail financial market, but only if it is potentially suitable and available to the investor.

### FIELD OF THE INVENTION

The present invention is related to computer software and more specifically to computer software for financial analysis.

### BACKGROUND OF THE INVENTION

Currently, the individual investor must rely on their investment advisor to provide the necessary investment advice as to which funds should be purchased or be required to do the required research themselves. In order to get the necessary investment advice, the individual needs to hire an investment advisor, and consequently pay for the advisor's time and expenses. However, many investment advisors do not even provide the full market comparative review nor compare the costs, suitability or returns amongst all available securities. The individual is further at risk of ending up with investments that provide a continuous income to the advisor at the expense of the investments' suitability and returns for the individual. In addition, many advisors are biased to a specific family of products as a result of a special relationship developed with certain securities issuers and mutual fund management companies. Performing the necessary research on your own is not a good or viable option either. Like an investment advisor, the investor needs to find details on the fund, gather all relevant information by searching newspapers, websites and databases, identify similar funds and do the full evaluation of comparing the funds. The amount of information that's required to be processed by an individual as well as the potential of errors from the information makes this task extremely hard to perform even on a one-time basis, let alone continuously.

As a result, there is a need for this system, which would (1) gather information not just from one source, but from a number of databases, (2) automatically adjust for errors and missing information, (3) filter for funds that are realistically available to the individual, and (4) do the necessary suitability and replacement analysis of the data instead of just sorting it. The system needs to be quick, automated and available at a low or no cost to the investor. Using the internet, database cross-referencing, and semantics analysis chronology is the only way cost-effective to achieve it. Otherwise it would require tremendous amounts of time and manual work raising the costs beyond the affordability for an average investor or investment advisor. Furthermore, manual work with such large amounts of often unstructured data is highly prone to human errors which may potentially nullify the results of the research.

### SUMMARY OF THE INVENTION

This invention is a new and innovative method and system, the utility of which is to provide an automated review of users' existing mutual funds or exchange traded funds and to recommend funds similar to the existing fund, but that are less expensive, less or equally risky, and perform equally or better than an existing fund. The system compiles multiple sources of data; adjusts for errors and missing data in the data-sources; uses semantics logic to filter only for funds available to the investor; matches these funds to the allocation profile of the investor's fund; selects only specific multiple fields needed for analysis; recommends only funds that offer equal or better performance, potentially fit the investor's profile and are available to the public investor.

The method and system is useful to the public because it provides investors at large with valuable recommendations as to which mutual funds or exchange traded funds are potentially good investments. Furthermore, upon acting on the recommendations it will potentially provide the investor with a comparable or better investment vehicle at a lower cost. The method and system goes far beyond the simple sorting function, as it requires special and specific algorithms to browse through and intelligently filter very large arrays of often inconsistent data.

The invention features an increased use of technology to create efficiencies and streamlining in mutual fund and exchange traded fund evaluation and replacement suggestions. The method will be the quickest, cheapest, easiest, and most accurate method available on the market today. The system can provide information to multiple investors, multiple times, and for multiple securities without incurring additional costs. The service will be available all the time regardless of market conditions or investor's net-worth. Due to scale-efficiencies, the cost to the investors can be reduced to an insignificant level. The investor does not even need to exhibit knowledge about their existing fund, nor be proficient in investment terminology or its process. The system will pull information automatically and suggest only funds from similar allocation profiles and only if they are better than the existing funds held by the investor.

The reason this has never been done before is because (1) the data collection technology was not available until recently, (2) the semantics logic algorithms required tremendous amounts of computer resources which were very expensive, (3) the data errors were too common to even attempt the adjustments for them (4) the back-end computer system would be too costly and time consuming to implement by an individual investor, so nobody could even have considered developing it for a personal portfolio, (5) the financial industry would not develop this kind of product due to conflicts of interest it would have created with its current operations and sales channels, (6) the number of traded securities such as Exchange Traded Funds (ETFs) was not diverse enough to provide the necessary variety to achieve replacement allocations diversified in sufficient number of asset classes.

### BRIEF DESCRIPTION OF THE DRAWINGS

FIG. 1 shows a simplified view of the initial set up required for the method

FIG. 2 shows a simplified view of the system

FIG. 3 shows a flowchart of the method

### DETAILED DESCRIPTION OF THE INVENTION

A new system and method that analyzes current mutual funds and exchange traded funds for individuals and then provides them with an automated potentially suitable trade suggestion taking full advantage of technological advances to provide a quick, inexpensive, and efficient transaction for the investor. Ideally, in its most preferable embodiment, it combines computer hardware, database cross-referencing and intelligent error adjustment, and computer readable statements and instructions, and uses the power of Internet technology and innovative procedures to spread and reduce their costs. The system and method is especially useful as it provides a list of funds that are potentially suitable to the particular investor, based on the user's specified current holdings (i.e. not requiring a specialized knowledge of the investment markets in any way).

“Fund,” as used herein and throughout this description, refers to any collective investment. Examples of a fund include but are not limited to a mutual fund, a money market fund, a stock index, a hedge fund, exchange traded fund, etc. . . .

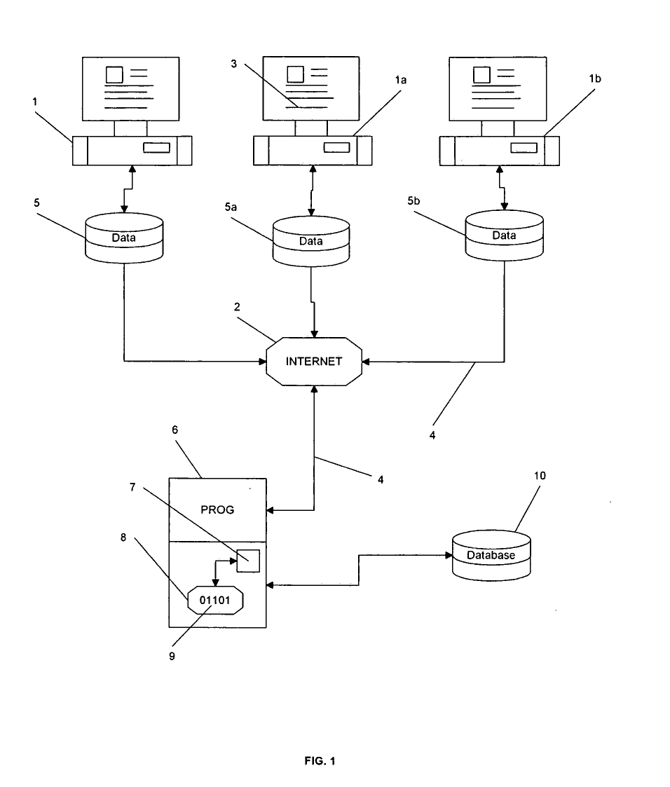

The preferred initial hardware embodiment required and its functionality is shown in FIG. 1. The system comprises a computer-readable medium (8) in a server (6), connected (4) to the internet (2), which in turn is connected either with wires or remotely to a plurality of remote terminals (1) of financial data providers who have uploaded financial information (3). A specially designed program (9), comprising computer readable statements and instructions, is stored in the computer readable medium (8), written in a language such as Java, Python, ASP, Sal or any other computer programming language and is capable, when run by a processor (7), of sorting and intelligently filtering data (including semantics methods) (5) provided by financial data providers and reorganizing into a new database (10) that can be stored in the computer readable medium. The database (10) can be updated from time to time by accessing updated data (5) using internet (2) and internet connection (4).

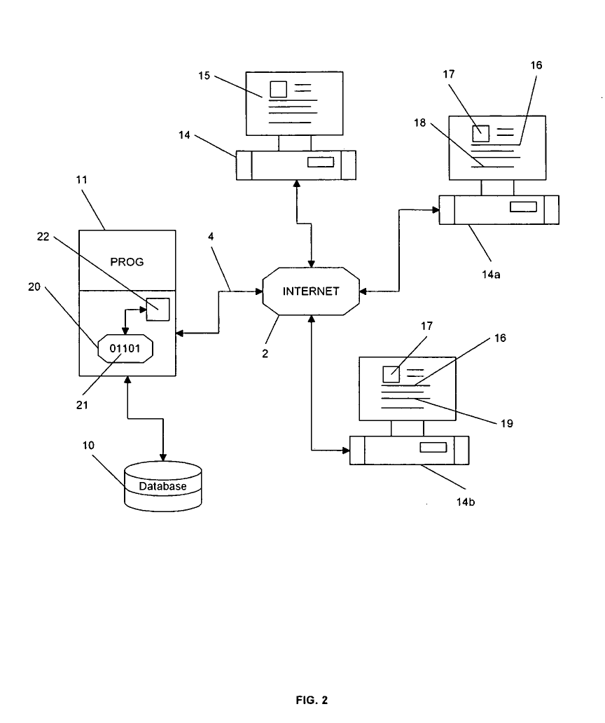

The functionality of the method within hardware embodiment and hardware itself are shown in FIG. 2. The system comprises a computer-readable medium (20) in a server (11), connected (4) to the internet (2), which in turn is connected either with wires or remotely to a plurality of remote terminals (14). A specially designed software application (21), comprising computer readable statements and instructions, is stored in the computer readable medium (20), written in a language such as Java, Python, ASP, Sal or any other computer programming language and is capable, when run by a processor (22), of processing information (15) provided by remote terminals (14) over the internet (2) and of processing information from the database (10) that has been created in the initial stage. The program is configured to display information on a remote terminal (14) including information from the database such as current fund information (17), suggested funds information (19), and input parameters used to select the suggested funds (16). The system is designed to receive information from multiple users and terminals (14, 14a, and 14b).

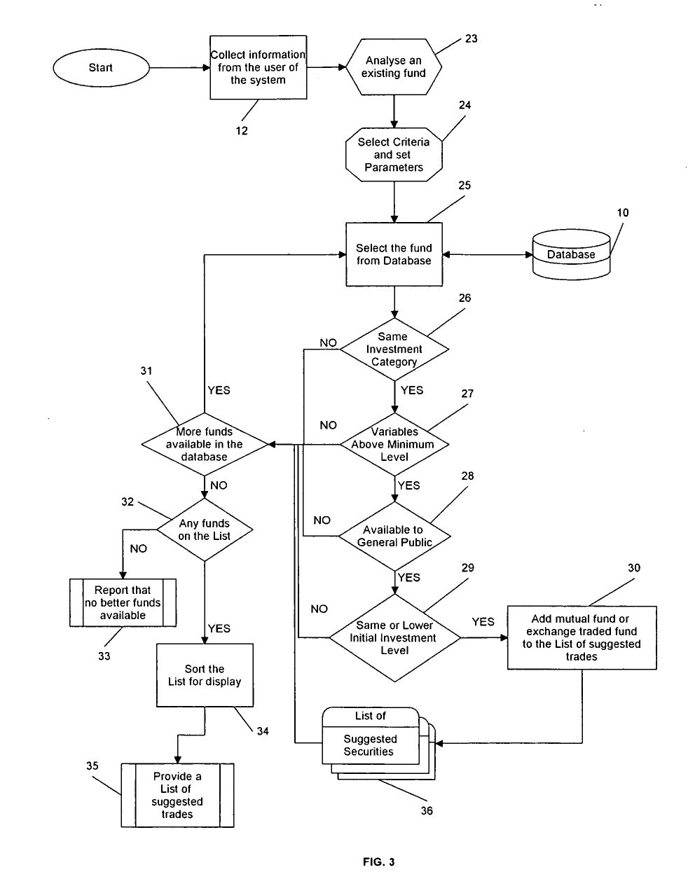

The functionality of the preferred embodiment of the system is shown in FIG. 3. First, the database should be created by the specially designed program in the server as described in FIG. 1. Next, the user of the system would connect to the server that can process information from database as described in FIG. 2. The user would provide fund information using forms or wizards that will be in turn collected by the server and processed by the software application. The fund data would be analyzed (23) by the software application and then the software application would select criteria such as investment category, third party rating or ranking, Sharpe ratio, fees, initial investment requirements, rate of return periods used for comparisons, and minimum assets under management that correspond to that fund and set those fund parameters (24) as the minimum value. The software application then would analyze each fund (25), using information from the database (10), as to whether it is a potentially suitable fund for the user. The software application would test whether the new fund is within the desired investment category (26), whether the fund parameters are above the previously set minimum values (27), whether the fund is available to the investor (28) and whether the new fund has the same or lower initial investment minimum requirement as the current invested amount (29). If the new fund fails to meet any of the above mentioned parameters or tests, the software application would ignore that fund and analyze another from its database. If the new fund meets all the parameters and tests, it will be placed (30) on the list of suggested funds (36).

The application software would analyze every fund in the database until every fund has been processed (31). If all the funds have been processed and no funds were placed on the suggested funds list (32) the software would display the message to the user that no better fund was available (33) and the process would end. If any funds have been placed on the suggested funds list, the funds will be sorted (34) by using the established criteria and parameters and displayed to the user (35) as a list of suggested replacement funds. The system may also project savings to the investor due to a decreased expense ratio calculated as if the investor were invested in the new fund as opposed to the existing fund over various periods of time. The process would end after the sorted suggested funds are provided to the user.

Modifications and variations to this invention will be apparent to those skilled in the art which will not depart from the spirit or scope of this invention.

I claim:

1. A system for processing fund information comprising:
a. a computer-readable medium;
b. a fund database having information about a plurality of funds;
c. a server connected to the fund database;
d. a processor;
e. a plurality of remote terminals;
f. computer readable statements and instructions residing in the computer readable medium, the statements and instructions configured to:
i. display information on a remote terminal;
ii. accept inputs from a remote terminal;
iii. accept an input from an investor indicating current fund holdings;
iv. accept an input from the investment fund data provider.

2. The system of claim 1, wherein the information in the fund database comprises information about funds such as asset size, gross performance, category, availability to the public, minimum investment requirements, third party rating or rankings of the funds and risk ratios.

3. The system in claim 2, wherein the criteria comprises a plurality of If/Then commands based on any of the information in the fund database.

4. The system in claim 1, wherein the computer is a personal computer.

5. The system of claim 1 wherein the investor can input information about the fund in order to generate a list of suggested replacement funds.

6. The system of claim 1 wherein the condition that triggers placement of the fund on the suggested replacement fund list comprises fund matching specific fund category, then better third party rating or ranking, then better return, then lower risk, and lower management fees.

7. The system of claim 6 wherein the condition that triggers placement of the fund on the suggested replacement fund list would also require the fund to be available to general public and minimum initial investment level of the fund to be smaller than the current investment amount of the current fund.

8. The system of claim 1, wherein the computer provides a user a list of suggested replacement funds.

9. The system of claim 8 which is further configured to allow the funds to be sorted by the user.

10. A system for processing fund information comprising:
g. a computer-readable medium;
h. data information records having information about a plurality of funds;
i. a server connected to the internet;
j. a processor;
k. a plurality of remote terminals;
l. a plurality of remote terminals that contain data information records;
m. computer readable statements and instructions residing in the computer readable medium, the statements and instructions configured to:
i. display information on a remote terminal;
ii. accept inputs from a remote terminal;
iii. accept an input from an investor indicating current fund holdings;
iv. accept an input from the investment fund data provider.

11. The system of claim 10 which is further configured to allow server access data information records having information about a plurality of funds located in the plurality of remote terminals of financial data suppliers.

12. The system of claim 10 which is further configured to allow server to process financial data about a plurality of funds and create a new fund database.

13. The system of claim 10 which is further configured to allow server to update a fund database by accessing financial data from financial data providers.

14. The system of claim 1 which is further configured to accept multiple requests from multiple users.

15. The system of claim 1 which is further configured to accept multiple requests from multiple users at the same time.

16. The system of claim 1 further configured to receive notifications and requests.

17. A computer readable memory for storing data for access by a processor carrying out the method of claims 1 and 10.

18. The system of claim 1 wherein the user is guided to input information about the fund by one or more wizards or pop ups.

19. The system of claim 1, which is further configured to send an instruction to the user indicating details, suggested terms and conditions, requirements and other information as may be required.

20. A computer readable memory having recorded thereon statements and instructions for interpretation and execution by a processor to carry out the method of claims 1 and 10.
